(19) United States
(12) Patent Application Publication
(10) Pub. No.: US 2019/0265902 A1
(43) Pub. Date: Aug. 29, 2019

(54) LIVE MIGRATION OF APPLICATIONS USING CAPI FLASH

(71) Applicant: INTERNATIONAL BUSINESS MACHINES CORPORATION, Armonk, NY (US)

(72) Inventors: Venkata N.S. Anumula, Hyderabad (IN); Vinod K. Boddukuri, Hyderabad (IN); Sudhir Maddali, Hyderabad (IN); Sanket Rathi, Hyderabad (IN)

(21) Appl. No.: 15/907,973

(22) Filed: Feb. 28, 2018

(51) Int. Cl. G06F 3/06; G06F 9/48

(52) U.S. Cl. CPC G06F 3/0647; G06F 2003/0697; G06F 3/0679; G06F 9/4856

(57) ABSTRACT

A method, computer system, and a computer program product for live application migration is provided. The present invention may include receiving, by a first host, a request to migrate an application to a second host. The present invention may include determining the received application request is using a first virtual LUN from a Coherent Accelerator Processor Interface (CAPI) Flash on the first host. The present invention may include identifying an associated CAPI context and a virtual LUN mapping table based on the determined application request. The present invention may include copying the identified virtual LUN mapping table and a plurality of application data to the second host. The present invention may include creating a CAPI context based on the identified virtual LUN mapping table and the plurality of application data. The present invention may include associating the copied virtual LUN mapping table to the second host.

### BACKGROUND

The present invention relates generally to the field of computing, and more particularly to application migration. Flash storage command line interface (CLI) commands may be used to create, resize or destroy logical units (LUNs) consumed by user applications. Flash storage CLI commands may be out-of-band and time consuming. Traditional application migration transfers the entire application data to be copied to a destination host when migrating the application from one host to another host.

### SUMMARY

Embodiments of the present invention disclose a method, computer system, and a computer program product for live application migration. The present invention may include receiving, by a first host, a request to migrate an application to a second host, wherein the application resides on an allocated physical logical unit (LUN) chunk. The present invention may also include determining the received application request is using a first virtual LUN from a Coherent Accelerator Processor Interface (CAPI) Flash on the first host. The present invention may then include identifying an associated CAPI context and a virtual LUN mapping table based on the determined application request. The present invention may further include copying the identified virtual LUN mapping table and a plurality of application data to the second host. The present invention may also include creating a CAPI context based on the identified virtual LUN mapping table and the plurality of application data. The present invention may then include associating the copied virtual LUN mapping table to the second host.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is a block diagram of traditional application migration versus Coherent Accelerator Processor Interface (CAPI) Flash application migration according to at least one embodiment;

FIG. 3 is a block diagram of two hosts configured with a CAPI Flash Adaptor according to at least one embodiment;

FIG. 4 is an operational flowchart illustrating a process for allocating a physical chunk to a Coherent Accelerator Processor Interface (CAPI) virtual logical unit (LUN) according to at least one embodiment;

FIG. 5 is an operational flowchart illustrating a process for live CAPI application migration according to at least one embodiment;

FIG. 6 is a block diagram of internal and external components of computers and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for live application migration that uses Coherent Accelerator Processor Interface (CAPI) Flash storage. As such, the present embodiment has the capacity to improve the technical field of CAPI application migration by creating a fast and efficient method to support live CAPI application migration across nodes. More specifically, efficient live migration of applications that use CAPI flash as slow memory includes copying CAPI meta-data and communicating the modifications of physical chunk allocation table to a host device. Live CAPI application migration using CAPI Flash may provide the advantage of a simple, transparent and fast method to migrate CAPI applications from one host to another. Simple, transparent and fast application migration may allow more efficient input-output (I/O) balancing across clustered servers, for example, for applications on in-memory non-structured query language (NoSQL) databases.

As previously described, flash storage command line interface (CLI) commands may be used to create, resize or destroy logical units (LUNs) consumed by user applications. Flash storage CLI commands may be out-of-band, time consuming and may also create difficulties for applications that have dynamic usage requirements of flash storage in terms of size and longevity of use. Traditional application migration transfers the entire application data to be copied to a destination host when migrating the application from one host to another host.

Overcoming out-of-band tasks and time consuming application migration, Coherent Accelerator Processor Interface (CAPI) adapters may be used to support virtual LUNs that may be created, resized and destroyed in-band by applications. Out-of-band tasks may transfer data through a separate dedicated channel than an in-band channel. Out-of-band tasks may, for example, manage network devices. An application migration program may present an efficient migration of CAPI applications that may use and share virtual LUNs from one host to another host.

Traditional in-memory application migration, for example, 2 servers running in a data center, may stop an application and dataset on Server 1 and move all of the application memory to Server 2. The application may be moved from Server 1 to Server 2 and the application may then be started on Server 2. Application migration may be slow since the footprint of data in-memory may contain a large amount of data.

Coherent Accelerator Processor Interface (CAPI) may attach a coherent accelerator to a server, such as IBM® Power8® System (IBM Power 8 System and all IBM Power 8 System-based trademarks and logos are trademarks or registered trademarks of International Business Machines Corporation and/or its affiliates). CAPI technology may be used to accelerate I/O functionality to deliver high input-output operations (IOPs) to a flash system storage LUN. Implementing an accelerator function unit (AFU) may be known as a CAPI Flash accelerator (i.e., CAPI Flash). CAPI Flash storage may be used as an extended memory for low latency high bandwidth I/O operations.

A CAPI Flash accelerator may allow user applications to perform I/O operations directly to a flash system storage LUN or multiple flash system storage LUNs using CAPI Flash library application programming interfaces (APIs). CAPI Flash APIs may bypass the operating system I/O stack. Bypassing the operating system may enable a user application to view the flash storage as a slow memory in terms of latency and access models.

A CAPI Flash application may use flash storage as a slow memory, for example, NoSQL (i.e., a non-relational database) in memory databases or a memory intensive application which may operate on large datasets that reside in random access memory (RAM). CAPI Flash may support features that allow grouping of LUNs as a storage pool. Management of the storage pool may be provided by CAPI Flash library APIs. The applications may share the storage pool in flexible units called chunks. Chunks may be created, resized and destroyed on the fly using CAPI Flash library APIs. A CAPI Flash accelerator functional unit (AFU) may provide assistance to internally map the virtual LUN to the physical LUN (i.e., LUN) logical block address (LBA) blocks.

A CAPI Flash accelerator may support creating flash storage chunks that may be accessed by CAPI adapter ports, however, CAPI Flash accelerators may be limited to one host. The CAPI Flash accelerator may not support sharing a LUN and corresponding storage pool chunks across multiple hosts. The limitation may also prevent applications using CAPI Flash as slow memory to migrate from one host to another host. Therefore, it may be advantageous to, among other things, provide a method to share flash LUNs and modifications to chunk allocation tables across multiple hosts and enable live migration of CAPI applications.

According to at least one embodiment, having multiple hosts share a flash LUN enables live migration of CAPI Flash applications. Allocating slow memory CAPI Flash chunks may provide efficient live migration of memory intensive applications. Applications, such as, in-memory NoSQL databases may be migrated across hosts by copying the entire content of the meta-data and the in-memory data blocks to the destination host memory and restarting the application at the destination host.

Migrating CAPI meta-data containing block maps between the hosts may allow live migration of memory intensive applications. An application migration program may provide live migration by communicating modifications to a physical chunk allocation table to another host and keeping the physical chunk allocation table consistent among the hosts that are sharing the CAPI Flash LUN. The application migration program may copy the data that resides in memory to the destination host by differentiating the in-memory application data from data on a flash storage (e.g., an external flash storage).

Migrating applications without using CAPI Flash may be time consuming, inefficient and may require application and LUN downtime. CAPI Flash slow memory chunks may be used and shared across hosts using a simplified migration of applications. The simplified migration may include data blocks that reside on the flash and may not need to be migrated. Instead, the meta-data containing the block maps may be migrated.

Migrating CAPI applications may use virtual LUNs on a shared CAPI Flash LUN. The CAPI Flash LUN may be shared with multiple hosts (e.g., computing devices, nodes, servers). CAPI Flash applications may use virtual LUNs as slow memory (i.e., extended memory). The virtual LUNs may have virtual chunks mapped to physical chunks on a shared CAPI Flash LUN. A chunk allocation table may be local to a host and may stay consistent with the multiple hosts using the shared CAPI Flash LUN by communicating modifications to a chunk allocation table.

For example, if an application sends a request to allocate a chunk on Host A, the driver or allocation manager identifies an unallocated physical chunk and then communicates the unallocated physical chunk location to Host B. Once Host B marks the chunk as allocated or as used by HostA in Host B's chunk allocation table and sends an acknowledgement to HostA, Host A then marks the unallocated chunk as allocated. Host A then is able to successfully migrate the application.

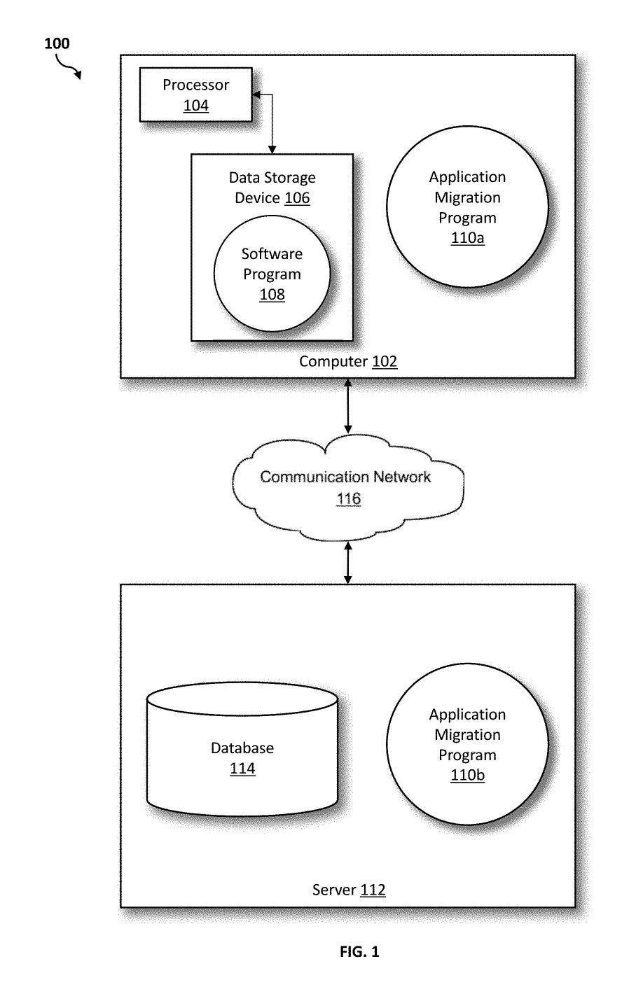

Referring to FIG. 1, an exemplary networked computer environment 100 in accordance with one embodiment is depicted. The networked computer environment 100 may include a computer 102 with a processor 104 and a data storage device 106 that is enabled to run a software program 108 and an application migration program 110a. The networked computer environment 100 may also include a server 112 that is enabled to run an application migration program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

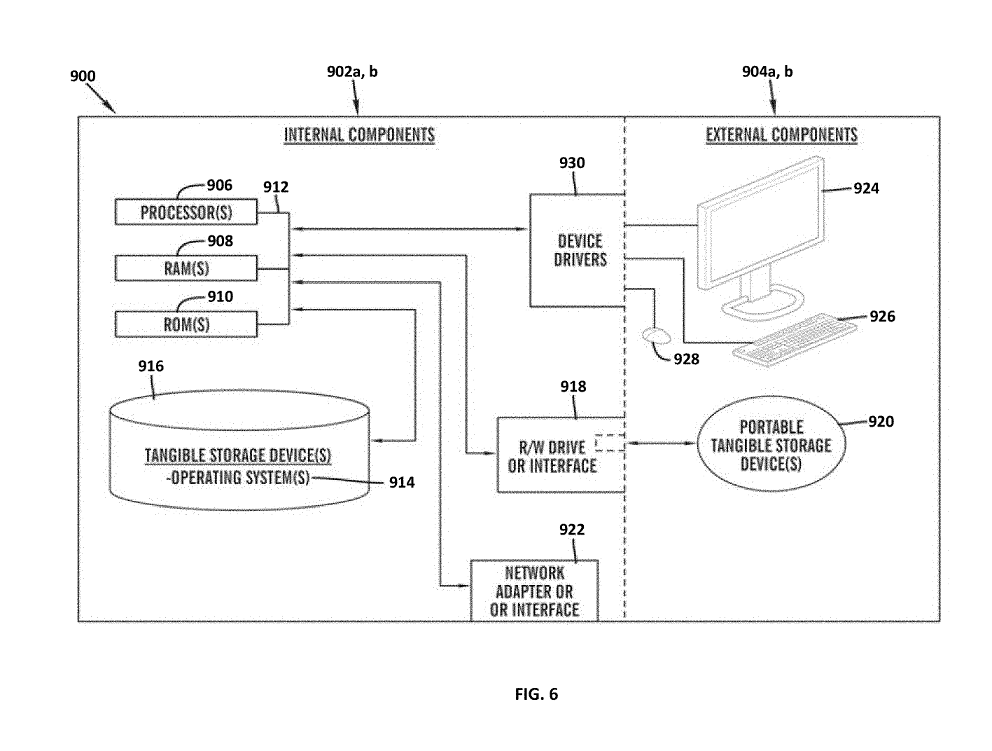

The client computer 102 may communicate with the server computer 112 via the communications network 116. The communications network 116 may include connections, such as wire, wireless communication links, or fiber optic cables. As will be discussed with reference to FIG. 6, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the application migration program 110a, 110b may interact with a database 114 that may be embedded in various storage devices, such as, but not limited to a computer/mobile device 102, a networked server 112, or a cloud storage service.

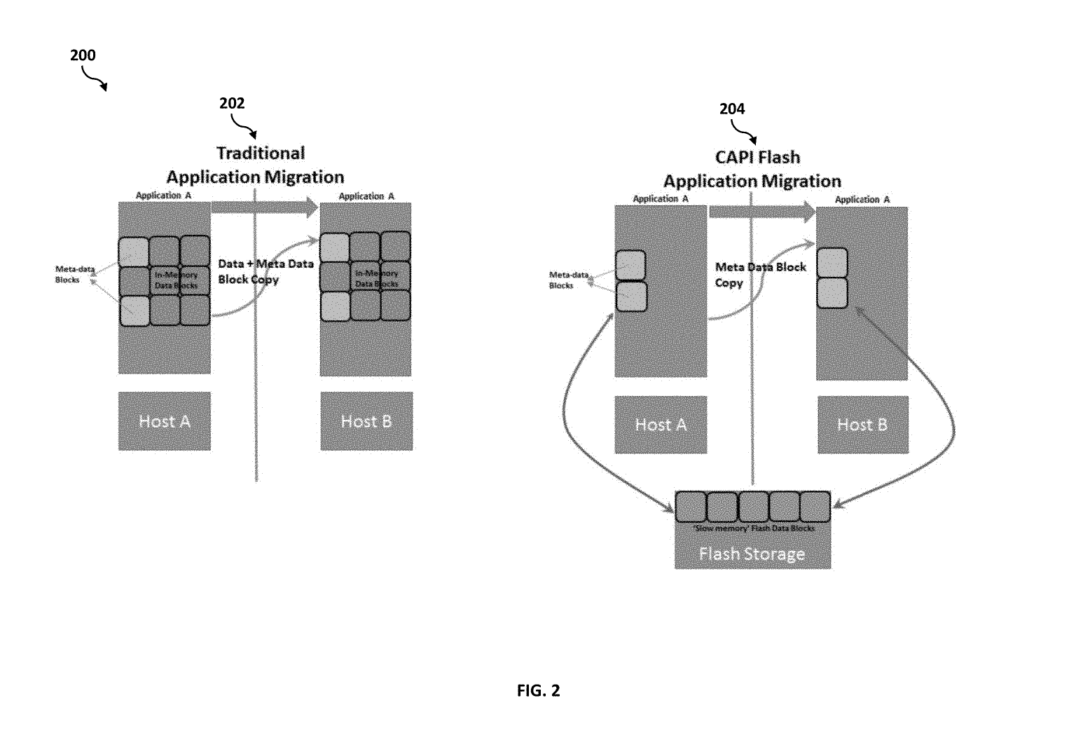

According to the present embodiment, a user using a client computer 102 or a server computer 112 may use the application migration program 110a, 110b (respectively) to allocate physical chunks to a CAPI virtual LUN for live application migration. The application migration method is explained in more detail below with respect to FIGS. 2-5.

Referring now to FIG. 2, a block diagram of traditional application migration versus CAPI Flash application migration 200 is depicted. Traditional application (i.e., traditional in-memory application) migration 202 may migrate Application A from Host A to Host B by copying all of the data and meta-data blocks used by the application from Host A to Host B. Copying may involve reading the application at Host A, copy over a communication network 116 and write the application at Host B. The traditional application migration 202 process may be time consuming and may block a client request to an application.

CAPI Flash application migration 204 may include a system in which the data for migration resides on an external flash system that is accessible at near memory latency. Since the flash system is external to a host, the external flash device may be shared with both Host A and Host B. In the CAPI Flash application migration 204 configuration, data may not need to be copied from Host A to Host B. Meta-data that identifies the data blocks used by an application that resides on Host A may be copied from Host A to Host B when migrating in-memory application. CAPI Flash application migration 204 may reduce the migration time compared to the traditional application migration 202.

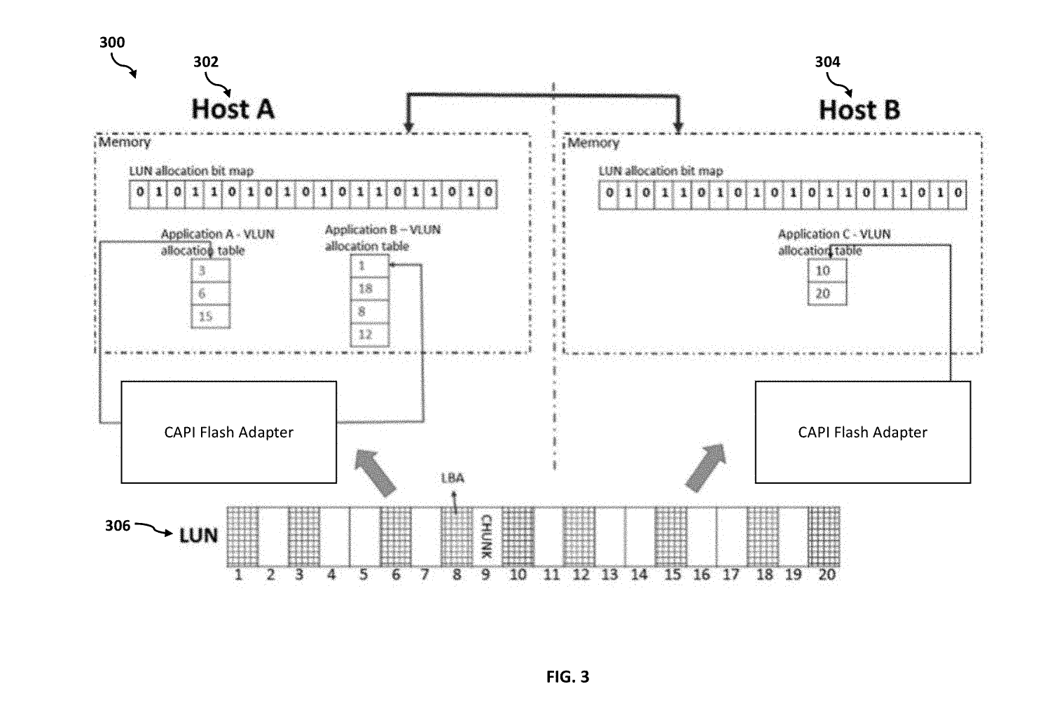

Referring to FIG. 3, a block diagram of two hosts configured with a CAPI Flash Adapter 300 according to at least one embodiment is depicted. Host A 302 includes memory with a LUN allocation bit map, Application A with a virtual LUN (VLUN) allocation table, Application B with a VLUN allocation table (i.e., mapping table or translation table), and a CAPI Flash Adapter. Host B 304 includes memory with a LUN allocation bit map, Application C with a VLUN allocation table and a CAPI Flash Adapter. The LUN 306 is configured with both Host A 302 CAPI adapter and Host B 304 CAPI adapter.

Host A and Host B may share the same LUN. The CAPI Flash Adapter on each host may have visibility to the LUN through a communication channel (e.g., a communication network 116, a serial connection such as a fibre channel or an infiniband connection). Both hosts may exchange the LUN bitmap information and may maintain individual virtual LUN translation tables for the applications running on the shared LUN. Application A and Application B may be running on Host A and Application C may be running on Host B. Application A, for example, has 3 allocated chunks and a translation table that maps VLUN chunk 0 to physical chunk 3, VLUN chunk 1 to physical chunk 6 and VLUN chunk 2 to physical chunk 15. Similarly, Application B, for example, is on Host A and has 4 allocated chunks with respective mapping to the Application B VLUN translation table. Application C on Host B, for example, has 2 allocated chunks on the physical LUN.

In a CAPI shared LUN mode, a chunk operation (i.e., allocate or free) may result in communication between the hosts (e.g., Host A and Host B). The communication may exchange the changes (i.e., the delta) to the LUN bit map through the communication channel. Once the changes are acknowledged by a host, the data structure modifications may be done to ensure consistency of the LUN.

A CAPI Flash library may maintain two resources to manage the storage pool. One resource may include the VLUN allocation table that may be indexed based on chunk number. The VLUN allocation table may store the corresponding physical chunk it maps to. The VLUN allocation table may also contain the LUN identification (ID) if the physical logical block addresses (LBAs) are mapped to multiple LUNs. One other resource the CAPI Flash library may maintain includes an allocation status bitmap of LUN physical chunk layout of the LUNs in the storage pool. The chunk may represent a collection of multiple physical contiguous LBAs on the LUN.

The chunk mapping virtual allocation table memory address may be shared with the CAPI Flash Adapter or AFU. The CAPI Flash Adapter may be used to translate the chunk number to the corresponding physical LBA and physical LUN. The CAPI Flash Adapter may translate the chunk number while the computing device is in operation (i.e., while I/O operations are active).

An application may exploit flash storage as slow memory and the application may operate on VLUN APIs provided by the CAPI Flash library. A VLUN may be defined, for example, as a contiguous group of virtual chunks. The application may use the APIs, such as flash_chunk_allocate, flash_chunk_resize, or flash_chunk_free to allocate, resize or free slow memory chunks.

Managing library resources between multiple hosts, for example Host A and Host B, may be implemented when both hosts, each having a CAPI adapter, are configured and both hosts have visibility to the same set of LUNs. Managing library resources between, for example Host A and Host B, may allow Host A parallel access to the chunk's slow memory without conflicting with Host B, and vice versa.

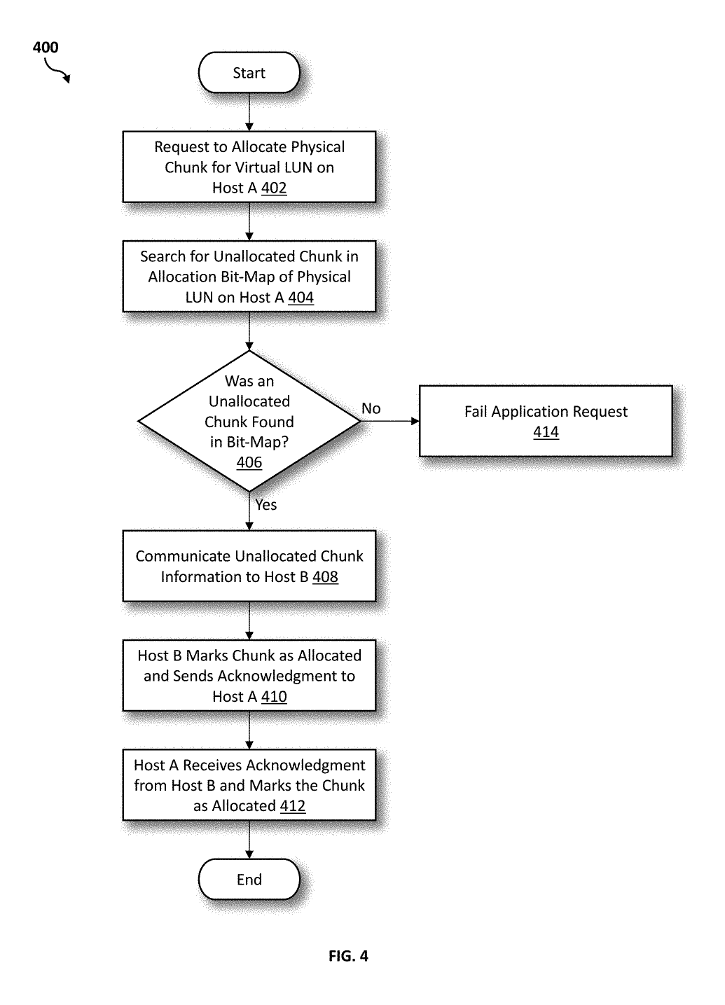

Referring to FIG. 4, an operational flowchart illustrating the exemplary physical chunk allocation to a CAPI virtual LUN process 400 used by the application migration program 110a, 110b according to at least one embodiment is depicted.

At 402, a request is made to allocate a physical chunk for a virtual LUN on Host A. The request may be made for Host A to operate an application and the application may, for example, need more memory. The request for memory may, for example, come to a driver or a memory manager (e.g., CAPI adapter or CAPI storage). The request may be for a chunk from a physical LUN to be allocated to Host A for operation of an application (e.g., a user application).

Next, at 404, a search is made for an unallocated chunk in the allocation bit-map of a physical LUN on Host A. Upon receiving the request to allocate a physical chunk, the driver on a CAPI slow memory manager may search the physical LUN for a chunk that is not currently allocated.

At 406, the application migration program 110a, 110b determines if there was an unallocated chunk found in the bit-map. The CAPI slow memory manager driver may communicate which chunk is unallocated based on the physical LUN search.

If the application migration program 110a, 110b determined that there are no unallocated chunks found in the bit-map at 406, then the application request will fail at 414.

However, if the application migration program 110a, 110b determined that there is an unallocated chunk found in the bit-map at 406, then Host A will communicate the unallocated chunk information to Host B at 408. After Host A communicates to Host B that Host A will be using the particular unallocated chunk on the physical LUN, Host A may mark or reserve the unallocated chunk for use. Marking the particular unallocated chunk for use will reserve the chunk so that another host may not use the marked chunk.

Next, at 410, Host B will mark the chunk as allocated and send an acknowledgment to Host A. Once Host B sends an acknowledgment to Host A, Host A may use the particular reserved chunk.

At 412, Host A receives an acknowledgment from Host B and then marks the chunk as allocated. Host A may mark the chunk as allocated in Host A's LUN allocation bit-map and then update Host A's virtual LUN mapping table. Host A may receive information regarding the physical chunk that will be used and then Host A may map the virtual LUN chunk to the physical LUN chunk. The application may be associated with the allocated physical LUN chunk. The virtual LUN chunk may be host specific to where the virtual LUN chunks are located.

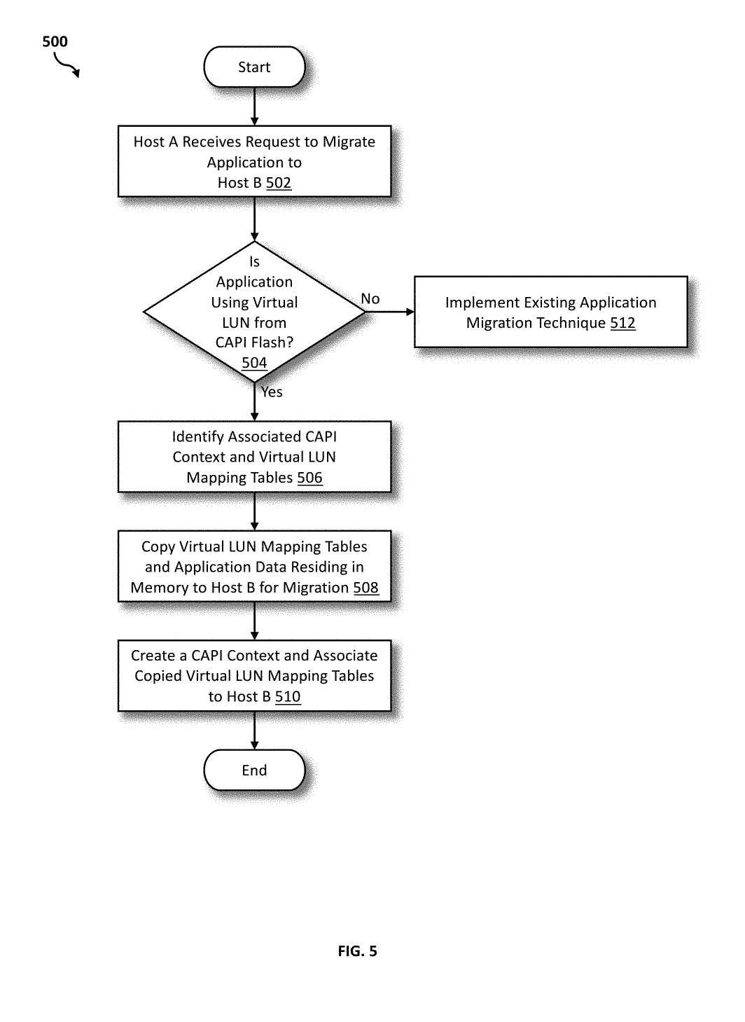

Referring to FIG. 5, an operational flowchart illustrating the exemplary live CAPI application migration process 500 used by the application migration program 110a, 110b according to at least one embodiment is depicted.

At 502, Host A receives a request to migrate application to Host B. The request may be made via a communication network 116. If the request is made while the application is in operation or while the application is active on Host A, the operation will complete and then not perform any new operations on the mapping table. Once Host A receives the request from Host B, the I/O to the virtual LUN used by the application on Host A may be temporarily quiesced.

Then, at 504, the application migration program 110a, 110b determines if the application is using virtual LUNs from CAPI Flash. A CAPI virtual LUN may be determined by viewing the process structure of the corresponding application. An application process structure may contain a list of CAPI contexts the application is associated with. Each CAPI context may have information on CAPI virtual LUNs associated with a CAPI context.

If the application is not using virtual LUNs from CAPI Flash at 504, then existing application migration techniques are implemented at 512. Existing methods may include traditional methods, such as traditional application migration methods not using CAPI Flash.

If the application is using virtual LUNs from CAPI Flash at 504, then associated CAPI context and virtual LUN mapping tables are identified at 506. The application migration program 110a, 110b may find the associated CAPI context and virtual LUN mapping table for the particular application being migrated. A context may be a term used for or associated with an application using a CAPI adapter. For example, Host A has Application X installed and Application X is using virtual LUNs from CAPI Flash. The application migration program 110a, 110b may identify the virtual LUN mapping for Application X on Host A.

At 508, virtual LUN mapping tables and application data residing in memory are copied to Host B for migration. The application migration program 110a, 110b may copy the mapping tables and the application data from Host A and send the data via a communication network 116 to Host B as part of the application migration. The virtual LUN mapping table associated with the application on Host A may be transferred to Host B. If a request to use the application comes from a user while the application is being transferred from Host A to Host B, the application in transit may be queued and propagated on Host B once Host B has the capability to operate the application.

Then, at 510, a CAPI context is created and the copied virtual LUN mapping tables are associated with Host B. Host B may clear the context of the virtual LUN mapping table that has been provided by Host A. Then a CAPI context is created and the virtual LUN mapping tables are associated on Host B as part of the application restart process on Host B. The virtual LUN data structures may be initialized based on the data structures received from Host A. The application may receive the data stored on the CAPI adapter storage for operation of the application on Host B.

It may be appreciated that FIGS. 2-5 provide only an illustration of one embodiment and do not imply any limitations with regard to how different embodiments may be implemented. Many modifications to the depicted embodiment(s) may be made based on design and implementation requirements.

FIG. 6 is a block diagram 900 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 6. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108 and the application migration program 110a in client computer 102, and the application migration program 110b in network server 112, may be stored on one or more computer-readable tangible storage devices 916 for execution by one or more processors 906 via one or more RAMs 908 (which typically include cache memory). In the embodiment illustrated in FIG. 6, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the application migration program 110a, 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the application migration program 110a in client computer 102 and the application migration program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the application migration program 110a in client computer 102 and the application migration program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926, and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

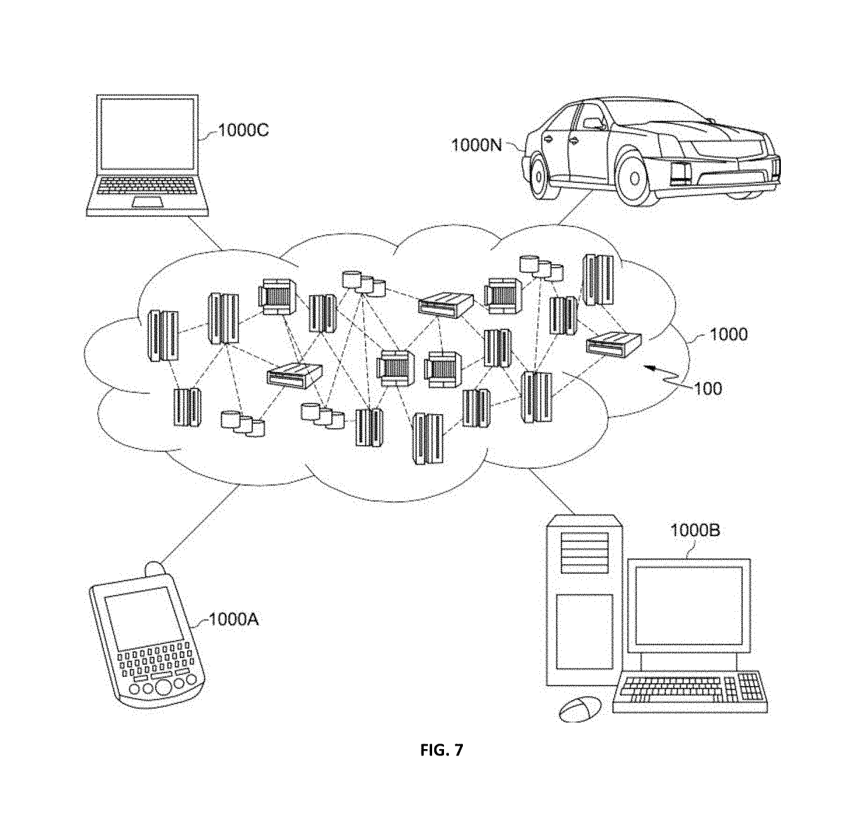

Referring now to FIG. 7, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 7 are intended to be illustrative only and that computing nodes 100 and cloud computing environment 1000 can communicate with any type of computerized device over any type of network and/or network addressable connection (e.g., using a web browser).

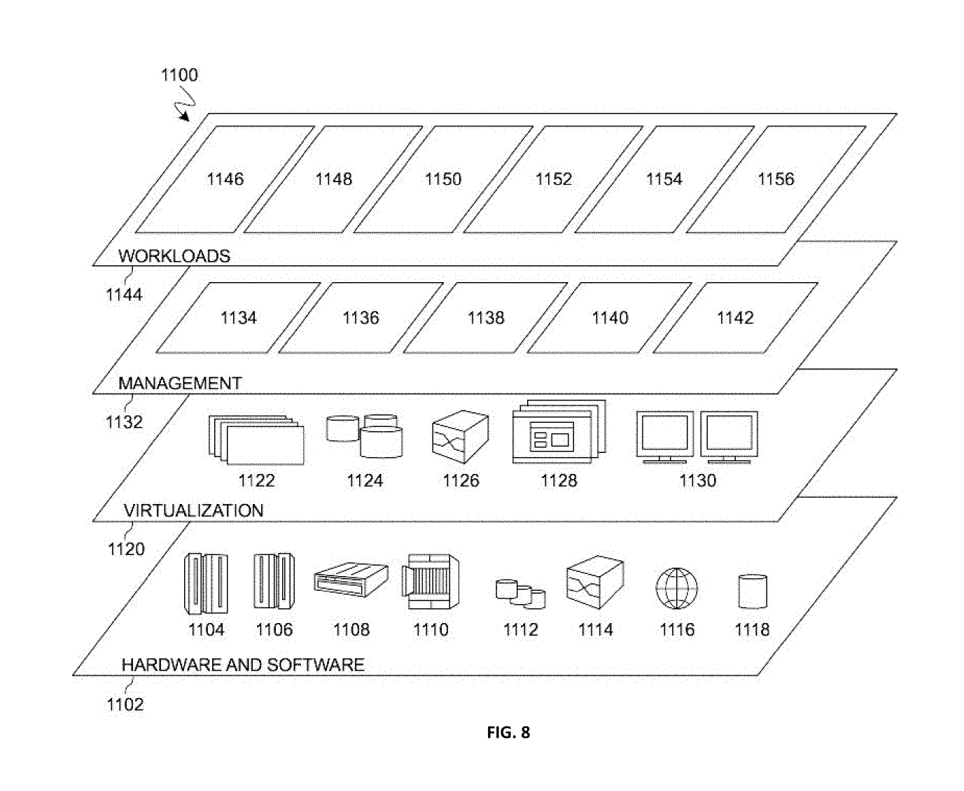

Referring now to FIG. 8, a set of functional abstraction layers 1100 provided by cloud computing environment 1000 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and live application migration 1156. An application migration program 110a, 110b provides a way to efficiently migrate memory-intensive application from one host to a different host without disrupting the application operations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for live application migration, the method comprising:
receiving, by a first host, a request to migrate an application to a second host, wherein the request uses a physical logical unit (LUN) chunk allocation for migration;
determining the received application request is using a first virtual LUN from a Coherent Accelerator Processor Interface (CAPI) Flash on the first host;
identifying a virtual LUN mapping table based on the determined request;
copying the identified virtual LUN mapping table and a plurality of application data from the first host to the second host;
creating a CAPI context for the application based on the copied virtual LUN mapping table and the plurality of application data; and
associating the copied virtual LUN mapping table to the created CAPI context on the second host.

2. The method of claim 1, wherein the physical LUN chunk allocation further comprises:
requesting the physical logical unit (LUN) allocation for the first virtual LUN on the first host;
searching for an unallocated chunk on the physical LUN based on the requested physical LUN allocation;
identifying the unallocated chunk on the physical LUN based on the search for the unallocated chunk;
communicating the identified unallocated chunk location to the second host;
marking, by the second host, the communicated unallocated chunk location;
acknowledging, by the second host, the marked unallocated chunk location to the first host; and
receiving, by the first host, the acknowledged unallocated chunk location.

3. The method of claim 1, wherein live application migration is implemented using more than two hosts that communicate within a cluster of hosts.

4. The method of claim 1, wherein the virtual LUN is private to a particular host, and wherein the virtual LUN is shared with a plurality of hosts using a CAPI Flash adapter.

5. The method of claim 2, wherein the physical LUN chunk is mapped to the first virtual LUN using an accelerator function unit (AFU) to translate a chunk number to a corresponding physical logical bit address (LBA), and wherein the AFU translates the chunk number while the computing device is in operation.

6. The method of claim 1, wherein the virtual LUN mapping table and the CAPI context are associated with the application.

7. The method of claim 2, wherein the unallocated chunk is identified by an allocation manager or a driver.

8. A computer system for live application migration, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
receiving, by a first host, a request to migrate an application to a second host, wherein the request uses a physical logical unit (LUN) chunk allocation for migration;
determining the received application request is using a first virtual LUN from a Coherent Accelerator Processor Interface (CAPI) Flash on the first host;
identifying a virtual LUN mapping table based on the determined request;
copying the identified virtual LUN mapping table and a plurality of application data from the first host to the second host;
creating a CAPI context for the application based on the copied virtual LUN mapping table and the plurality of application data; and
associating the copied virtual LUN mapping table to the created CAPI context on the second host.

9. The computer system of claim 8, wherein the physical LUN chunk allocation further comprises:
requesting the physical logical unit (LUN) allocation for the first virtual LUN on the first host;
searching for an unallocated chunk on the physical LUN based on the requested physical LUN allocation;
identifying the unallocated chunk on the physical LUN based on the search for the unallocated chunk;
communicating the identified unallocated chunk location to the second host;
marking, by the second host, the communicated unallocated chunk location;
acknowledging, by the second host, the marked unallocated chunk location to the first host; and
receiving, by the first host, the acknowledged unallocated chunk location.

10. The computer system of claim 8, wherein live application migration is implemented using more than two hosts that communicate within a cluster of hosts.

11. The computer system of claim 8, wherein the virtual LUN is private to a particular host, and wherein the virtual LUN is shared with a plurality of hosts using a CAPI Flash adapter.

12. The computer system of claim 9, wherein the physical LUN chunk is mapped to the first virtual LUN using an accelerator function unit (AFU) to translate a chunk number to a corresponding physical logical bit address (LBA), and wherein the AFU translates the chunk number while the computing device is in operation.

13. The computer system of claim 8, wherein the virtual LUN mapping table and the CAPI context are associated with the application.

14. The computer system of claim 9, wherein the unallocated chunk is identified by an allocation manager or a driver.

15. A computer program product for live application migration, comprising:
one or more computer-readable tangible storage media and program instructions stored on at least one of the one or more computer-readable tangible storage media, the program instructions executable by a processor to cause the processor to perform a method comprising:
receiving, by a first host, a request to migrate an application to a second host, wherein the request uses a physical logical unit (LUN) chunk allocation for migration;
determining the received application request is using a first virtual LUN from a Coherent Accelerator Processor Interface (CAPI) Flash on the first host;
identifying a virtual LUN mapping table based on the determined request;
copying the identified virtual LUN mapping table and a plurality of application data from the first host to the second host;
creating a CAPI context for the application based on the copied virtual LUN mapping table and the plurality of application data; and
associating the copied virtual LUN mapping table to the created CAPI context on the second host.

16. The computer program product of claim 15, wherein the physical LUN chunk allocation further comprises:
requesting the physical logical unit (LUN) allocation for the first virtual LUN on the first host;
searching for an unallocated chunk on the physical LUN based on the requested physical LUN allocation;
identifying the unallocated chunk on the physical LUN based on the search for the unallocated chunk;
communicating the identified unallocated chunk location to the second host;
marking, by the second host, the communicated unallocated chunk location;
acknowledging, by the second host, the marked unallocated chunk location to the first host; and
receiving, by the first host, the acknowledged unallocated chunk location.

17. The computer program product of claim 15, wherein live application migration is implemented using more than two hosts that communicate within a cluster of hosts.

18. The computer program product of claim 15, wherein the virtual LUN is private to a particular host, and wherein the virtual LUN is shared with a plurality of hosts using a CAPI Flash adapter.

19. The computer program product of claim 16, wherein the physical LUN chunk is mapped to the first virtual LUN using an accelerator function unit (AFU) to translate a chunk number to a corresponding physical logical bit address (LBA), and wherein the AFU translates the chunk number while the computing device is in operation.

20. The computer program product of claim 15, wherein the virtual LUN mapping table and the CAPI context are associated with the application.
